(19) United States
(12) Patent Application Publication
(10) Pub. No.: US 2026/0070475 A1
(43) Pub. Date: Mar. 12, 2026

(54) WELDING TUBES IN MULTI-CHAMBER CELLS

(71) Applicant: LEAR CORPORATION, Southfield, MI (US)

(72) Inventor: Grzegorz Kasperczyk, Warszawa (PL)

(21) Appl. No.: 18/829,477

(22) Filed: Sep. 10, 2024

(51) Int. Cl. B60N 2/66; A61H 9/00; B23K 9/23; B60N 2/90

(52) U.S. Cl. CPC B60N 2/665; A61H 9/0078; B23K 9/23; B60N 2/976

(57) ABSTRACT

A multi-chamber bladder is comprised of a plurality of stacked bladder sheets including at least a first bladder sheet, a second bladder sheet, and a third bladder sheet, wherein the first bladder sheet and the second bladder sheet have aligned chamber holes, and wherein the third bladder sheet encloses one end of the multi-chamber bladder. A tube is positioned between the second and third bladder sheets such that one end of the tube extends outward of an outer perimeter of the plurality of bladder sheets. A single attachment interface attaches the tube and the outer perimeter of the second and third bladder sheets together.

### BACKGROUND

A vehicle seat comprises a seat cushion and seat back that may include inflatable bladders for massage, lumbar, or bolster purposes.

### BRIEF DESCRIPTION OF THE DRAWINGS

FIG. 1 is a perspective view of a seat assembly.

FIG. 2 is a perspective view of a seat bladder assembly and associated fluid supply system.

FIG. 3 is a schematic illustration of a multi-chamber bladder with an associated tube and mandrel supporting the tube.

FIG. 4 is an enlarged perspective view of a single attachment interface that secures adjacent bladder sheets and a tube together to form a multi-chamber bladder.

FIG. 5A is a top view of an inner portion of a multi-chamber bladder.

FIG. 5B is a top view of the inner portion of FIG. 5A supported on a tooling apparatus with a tube and mandrel in a welding position.

FIG. 5C is similar to FIG. 4B but with an end bladder sheet placed over the mandrel and tube.

FIG. 5D is a perspective view of a finished multi-chamber bladder being removed from the tooling apparatus.

FIG. 5E is a perspective view of a finished multi-chamber bladder having the mandrel removed.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

It should be understood that terms such as “about,” “substantially,” and “generally” are not intended to be boundaryless terms, and should be interpreted consistent with the way one skilled in the art would interpret those terms.

This disclosure relates to a multi-chamber bladder with an associated tube positioned between adjacent bladder sheets such that one end of the tube extends outward of an outer perimeter of the bladder sheets, wherein a single attachment interface is formed that attaches the tube and the outer perimeter of the bladder sheets together. In implementations, the single attachment interface is formed via a single welding operation.

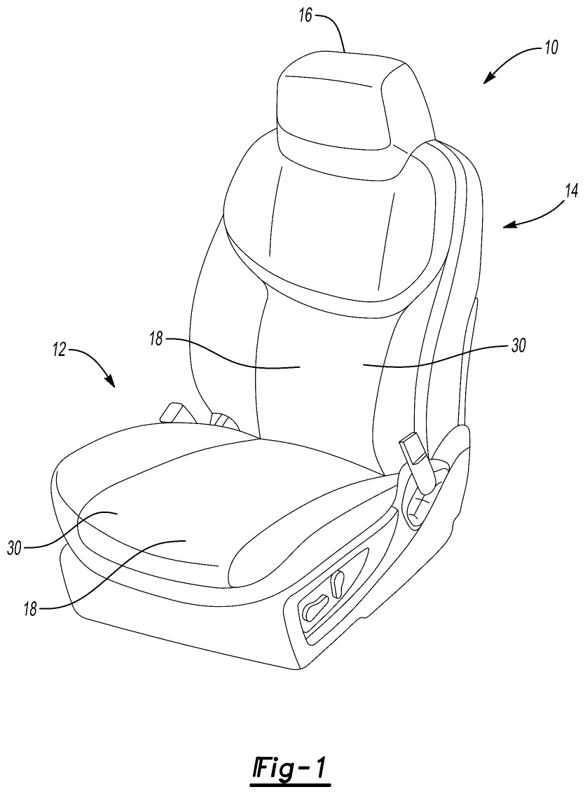

FIG. 1 illustrates a seat assembly 10 according to one example embodiment. The seat assembly 10 may be utilized as a vehicle seat assembly 10 for seating in a vehicle, such as an automobile, an aircraft, a watercraft, or any other seating environment. The seat assembly 10 includes a seat bottom 12, which may be adapted to be mounted for motor-driven adjustable translation in a fore and aft direction and in an up and down direction of a vehicle. The seat assembly 10 includes a seat back 14, which may be pivotally connected to the seat bottom 12 to extend generally upright relative to the seat bottom 12 for pivotal adjustment about an axis relative to the seat bottom 12.

The seat back 14 may include a head restraint 16 that may be configured to support the head of a seat occupant. The head restraint 16 may be disposed at the top of the seat back 14. The head restraint 16 may be unitary with the seat back 14 or may be a separate component that is adjustably positionable with respect to the top of the seat back 14. The seat bottom 12 may be configured to support a seat occupant. In a vehicular application, the seat bottom 12 may be mounted to a support surface, such as a vehicle floor. It should be understood that this is just one example of a seat configuration, and that other configurations could also be utilized.

In implementations, each of the seat back 14 and seat bottom 12 include a foam cushion 18. The foam cushion 18 can be conventionally secured to a seat frame (not shown) by any method generally known in the art. The foam cushions 18 can independently comprise any suitable comfort foam material such as, but not limited to, a suitable resilient polymer, and can independently be formed in any suitable manner. For example, the foam cushions 18 may be formed of conventional polyurethane foam, soy-based foam, silicone, thermoplastic olefins, thermoplastic urethanes, and/or natural oil-based expanded polyurethanes, soy-based polyurethane, polymer fibers, non-woven polyester pads, latex foams and the like. The foam cushions 18 are formed of any suitable comfort material that provides soft resilience as the seat assembly is deflected during use when an occupant is in a seated position.

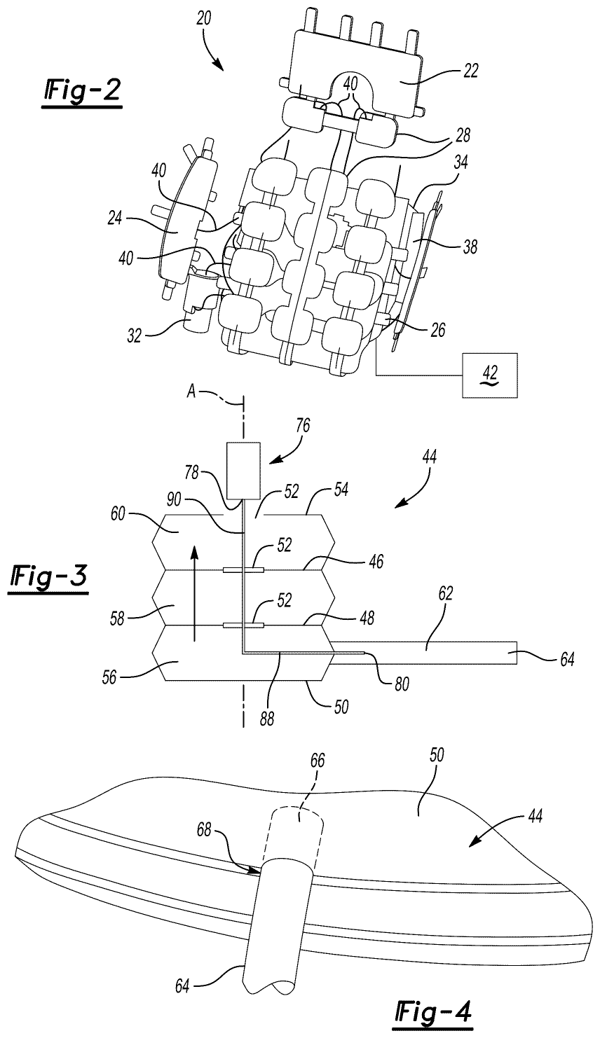

FIG. 2 shows an example of a bladder assembly and associated fluid supply system 20 that can be used with the seat assembly 10. In implementations, the bladder assembly and associated fluid supply system 20 may include one or more of the following: a shoulder bladder 22; one or more bolster bladders 24; one or more lumbar bladders 26; one or more massage bladders 28. In implementations, these bladders 22, 24, 26, 28 are supported by one of the cushions 18 of the seat assembly 10. In implementations, a trim cover 30 may be disposed over or upon the cushions 18 and may cover the bladders 22, 24, 26, 28. The trim cover 30 provides at least a portion of a visible exterior surface of the seat assembly 10. In implementations, the trim cover 30 may include a plurality of trim panels that may be assembled in any suitable manner, such as by stitching. The trim panels may be made of any suitable material or materials, such as fabric, leather, vinyl, or combinations thereof.

In implementations, the shoulder bladder 22 provides upper body support, the bolster bladders 24 provide lateral support to a seated occupant when the vehicle experiences a turn or cornering, the lumbar bladders provide lower back support, and the massage bladders 28 are used for massaging designated body areas.

In implementations, the bladder assembly and associated fluid supply system 20 may include a compressor or pneumatic pump 32 connected to a valve bank 34 with a plurality of valves 38 to provide a source of fluid to the bladders 22, 24, 26, 28. In one example, the valves 38 are associated with actuators such as solenoids, shape-memory alloy members, or other types of actuating members. In implementations, a plurality of fluid tubes 40 are used to connect the various bladders 22, 24, 26, 28 to the fluid supply system 20. The fluid supply system 20 also includes a seat control module identified generally as a controller 42. In one example, the controller 42 regulates compressed air into and out of the bladder assemblies 22, 24, 26, 28 in the seat assembly 10. The controller 42 and associated valve actuators may be installed in the seat bottom 12 or seat back 14, for example, or the controller 42 can be installed under the seat assembly 10, or anywhere suitable in a vehicle.

The controller 42 may include a processing unit and non-transitory memory for executing various control strategies. The processing unit can be a custom made or commercially available processor, a central processing unit (CPU), or generally any device for executing software instructions. The memory can include any one or combination of volatile memory elements and/or nonvolatile memory elements. The processing unit can be programmed to execute one or more programs stored in the memory. The programs may be stored in the memory as software code, for example. The programs stored in the memory may include one or more additional or separate programs, each of which includes an ordered list of executable instructions for implementing logical functions associated with controlling the valve bank. While shown as a single controller, the controller 42 may be comprised of one or more controllers. The controller 42 may also be in communication with, and responsive to instructions from, another controller.

In implementations, one or more of the bladders 22, 24, 26, 28 may comprise a multi-chamber bladder 44 as shown in FIG. 3. The multi-chamber bladder 44 may comprise a massage bladder 28, a lumbar bladder 26, a bolster bladder 24, or a shoulder bladder 22.

In one example, the multi-chamber bladder 44 comprises a discrete inflatable/deflatable pouch or cell having a plurality of fluidly connected inner chambers. In implementations, the multi-chamber bladder 44 may be comprised of a plurality of stacked bladder sheets, e.g., flat sheets of polymeric material including at least a first bladder sheet 46, a second bladder sheet 48, and a third bladder sheet 50, wherein the first bladder sheet 46 and the second bladder sheet 48 have aligned chamber holes 52, and wherein the third bladder sheet 50 encloses one end of the multi-chamber bladder 44. An additional fourth bladder sheet 54 may enclose an opposite end of the multi-chamber bladder 44. Additional, inner bladder sheets could also be used as needed.

In one example, the bladder sheets are comprised of a thermoplastic polyurethane material (TPU).

In one example, a first chamber 56 is formed between the second 48 and third 50 bladder sheets, a second chamber 58 is formed between the first 46 and second 48 bladders, and a third chamber 60 is formed between the fourth bladder sheet 54 and first bladder sheet 46. The chambers 56, 58, 60 are in fluid communication with each other via the aligned chamber holes 52.

In implementations, the chambers 56, 58, 60 of the multi-chamber bladder 44 comprise a series of selectively inflatable chambers that are aligned along a common axis A such that the chambers 56, 58, 60 inflate and deflate in succession.

In implementations, a tube 62, e.g., a hollow cylindrical body, is positioned between the second 48 and third 50 bladder sheets such that one end 64 of the tube extends outward of an outer perimeter of the bladder sheets 48, 50, and an opposite end 66 is located with the first chamber 56 as shown in FIG. 4.

In implementations, a single attachment interface 68 attaches the tube 62 and the outer perimeter of the second 48 and third 50 bladder sheets together. In implementations, the single attachment interface 68 comprises a common attachment for both bladder sheets 48, 50 and the tube 62.

In implementations, the single attachment interface 68 comprises a welded interface. In one example, the welded interface is provided via a welding operation such as high frequency welding or other suitable welding operations, for example.

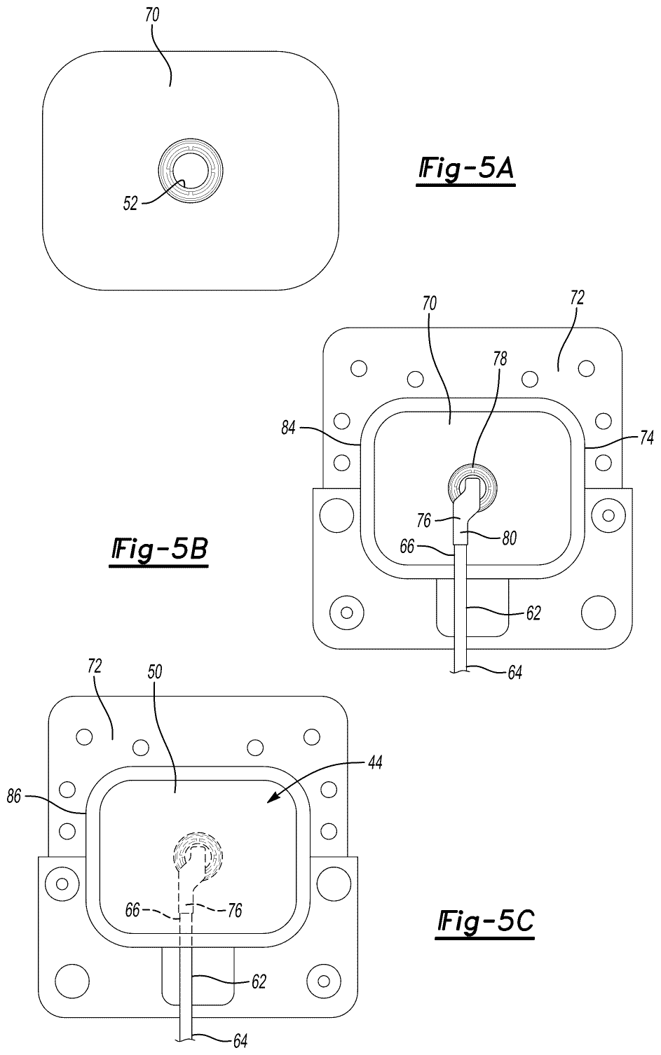

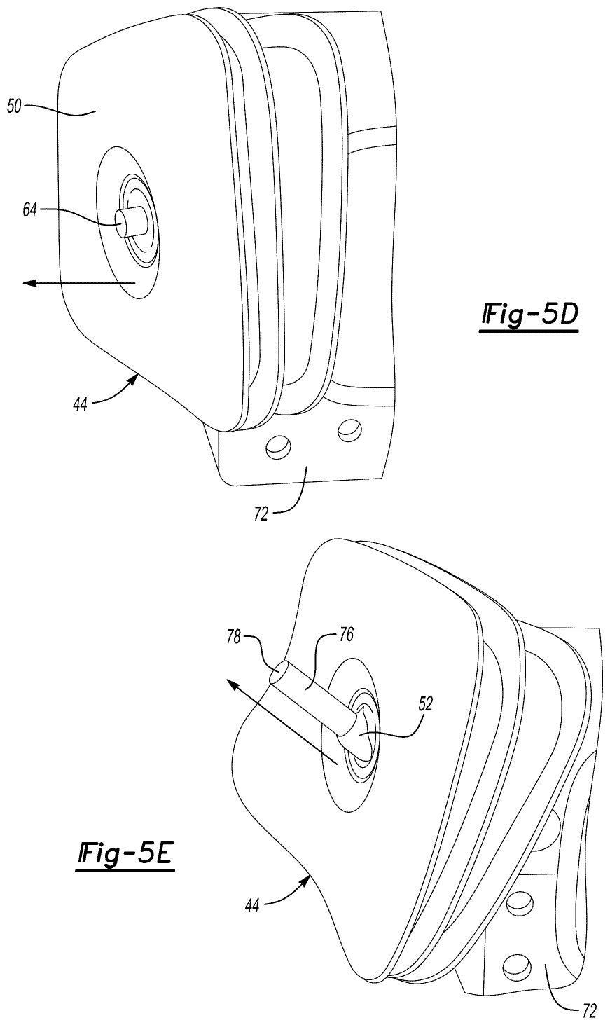

In implementations, a method for attaching a tube 62 to a multi-chamber bladder 44 comprises welding the tube 62 and a perimeter of the bladder with one welding step. For example, the method includes attaching adjacent inner bladder sheets 48, 46 having aligned chamber holes 52, e.g., coaxial holes, together to provide an inner portion 70 of the multi-chamber bladder 44 as shown in FIG. 5A.

Next, the inner portion 70 of the multi-chamber bladder 44 is supported on a tooling platform 72 that includes a welding electrode 74 as shown in FIG. 5B. In one example, the welding electrode 74 comprises an aluminum or brass body designed to carry high-frequency electrical currents to generate heat and weld materials together.

In implementations, a mandrel 76 has a first end 78 that is then inserted through the aligned chamber holes 52, and a second end 80 that supports the inner end 66 of the tube 62 as shown in FIG. 5B. In one example, the mandrel 76 comprises a rod or bar that is inserted into a hollow workpiece for support while the workpiece is being processed.

In this example, the tube 62 is thus placed on top of the inner portion 70 comprised of bladder sheets 48, 50 such that the inner end 66 will be located in the first chamber 56 and the opposite end 64 will extend beyond a perimeter 84 of the inner portion 70 as shown in FIG. 5B.

In implementations, the end bladder sheet 50 is then placed over the portion 70, the mandrel 76, and the tube 62 such that the end 64 of the tube 62 extends outward of an outer perimeter 86 of the end bladder sheet 50 as shown in FIG. 5C.

In implementations, the multi-chamber bladder 44 is then formed by activating the welding electrode 74 to weld the tube 62 and the outer perimeter 86 of the end bladder sheet 50 and the outer perimeter 84 of the inner bladder portion 70 together in a single welding operation (see FIG. 5C). Thus, the welding operation about a perimeter of the stacked bladders also welds the tube in place without requiring any other material handling or subsequent welding operations.

Finally, once the weld attachment interface 68 is complete, the multi-chamber bladder 44 is then removed from the tooling platform 72 (FIG. 5D), and the mandrel 76 can then be pulled out from an opposite side of the multi-chamber bladder 44 as shown in FIG. 5E.

In implementations the mandrel 76 comprises at least a first portion 88 and a second portion 90 that are non-colinear with each other as shown in FIG. 3. In one example, the portions 88, 90 comprise linear, rigid bar bodies.

In one example, the first portion 88 is perpendicular to the second portion 90.

In one example, the first portion 88 and second portion 90 form a L-shape.

In one example, the second portion 90 is longer than the first portion 88.

In one example, the first portion 88 is associated with the tube 62 and the second portion 90 extends out of the multi-chamber bladder.

In implementations, the subject method and apparatus can be used for any tubing lengths, e.g., long tube or short tube configurations. For example, the method and apparatus can be used for tubing lengths greater than 20 cm.

In implementations, each tube diameter can be welded once the bladder inner hole is larger than an external tube diameter. In one example, a larger volume, e.g., a larger size, bladder will require a larger tube diameter to meet the demand for inflation/deflation time. In implementations, generally, for lumbar/shoulder/bolsters bladders, 6 (external) mm/4 (internal) mm tube diameter or 4.7/3 mm tube diameter may be used. In implementations, generally, for massage bladders 3/1.5 mm tube diameter may be used.

In implementations an assembly comprises: a multi-chamber bladder comprised of a plurality of stacked bladder sheets including at least a first bladder sheet, a second bladder sheet, and a third bladder sheet, wherein the first bladder sheet and the second bladder sheet have aligned chamber holes, and wherein the third bladder sheet encloses one end of the multi-chamber bladder; a tube positioned between the second and third bladder sheets such that one end of the tube extends outward of an outer perimeter of the plurality of bladder sheets; and a single attachment interface that attaches the tube and the outer perimeter of the second and third bladder sheets together.

The assembly may include any additional features either alone or in any combination thereof. In one example, the multi-chamber bladder comprises a series of selectively inflatable chambers in fluid communication with each other.

In one example, the multi-chamber bladder comprises a massage bladder, lumbar bladder, or bolster bladder.

In one example, the single attachment interface comprises a welded interface.

In one example, the plurality of stacked bladder sheets are comprised of a polyurethane material.

In implementations a method comprises: attaching an inner bladder sheet having a first chamber hole to an additional bladder sheet having a second chamber hole aligned with the first chamber hole; placing a tube on the inner bladder sheet; inserting a mandrel through the first and second chamber holes and supporting a first end of the tube; placing an end bladder sheet over the inner bladder sheet and tube such that a second end of the tube extends outward of an outer perimeter of the end bladder sheet; and forming a multi-chamber bladder by welding the tube and the outer perimeter of the end bladder sheet and inner bladder sheet together in a single welding operation.

The method may include any additional features either alone or in any combination thereof. In one example, the method includes supporting the inner bladder sheet, the additional bladder sheet, and the end bladder sheet on a welding electrode.

In one example, the method includes removing the multi-chamber bladder from the welding electrode subsequent to the welding operation.

In one example, the method includes removing the mandrel from the tube and the multi-chamber bladder via the first and second chamber holes after removing the multi-chamber bladder from the welding electrode.

In one example, the welding operation comprises a high frequency welding operation that provides a single attachment interface that attaches the tube and the outer perimeter of the inner bladder sheet and the end bladder sheet together.

In one example, the mandrel comprises at least a first portion and a second portion that are non-colinear with each other.

In one example, the first portion comprises a first linear bar and the second portion comprises a second linear bar that is perpendicular to the first linear bar.

In one example, the method includes forming the bladder sheets from a polyurethane material.

In implementations an apparatus comprises: a plurality of bladder sheets including at least a first bladder sheet and a second bladder sheet attached to each other and having aligned chamber holes, and a third bladder sheet that is stacked on the second bladder sheet and encloses one end of a bladder; a welding electrode that supports the plurality of bladder sheets; a tube positioned between the second and third bladder sheets such that one end of the tube extends outward of an outer perimeter of the plurality of stacked bladder sheets; and a mandrel with one end held fixed and an opposite end inserted through the aligned chamber holes and engageable with an end of the tube.

The apparatus may include any additional features either alone or in any combination thereof. In one example, the mandrel comprises at least a first portion and a second portion that are non-colinear with each other.

In one example, the first portion and the second portion are perpendicular to each other.

In one example, one of the first portion and the second portion is longer than the other of the first portion and the second portion.

In one example, one of the first portion and the second portion is associated with the tube and the other of the first portion and the second portion extends out of the bladder.

In one example, the welding electrode provides a single weld interface that attaches the tube and the outer perimeter of the second bladder sheet and the third bladder sheet together.

In one example, the first bladder sheet, the second bladder sheet, and the third bladder sheet comprise a multi-chamber bladder with the one end of the tube that extends outward of the outer perimeter of the plurality of bladder sheets being connectable to a fluid supply and the opposite end of the tube being in fluid communication with a chamber of the multi-chamber bladder.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. An assembly comprising:
a multi-chamber bladder comprised of a plurality of stacked bladder sheets including at least a first bladder sheet, a second bladder sheet, and a third bladder sheet, wherein the first bladder sheet and the second bladder sheet have aligned chamber holes, and wherein the third bladder sheet encloses one end of the multi-chamber bladder;
a tube positioned between the second and third bladder sheets such that one end of the tube extends outward of an outer perimeter of the plurality of bladder sheets; and
a single attachment interface that attaches the tube and the outer perimeter of the second and third bladder sheets together.

2. The assembly of claim 1, wherein the multi-chamber bladder comprises a series of selectively inflatable chambers in fluid communication with each other.

3. The assembly of claim 1, wherein the multi-chamber bladder comprises a massage bladder, lumbar bladder, or bolster bladder.

4. The assembly of claim 1, wherein the single attachment interface comprises a welded interface.

5. The assembly of claim 1, wherein the plurality of stacked bladder sheets are comprised of a polyurethane material.

6. A method comprising:
attaching an inner bladder sheet having a first chamber hole to an additional bladder sheet having a second chamber hole aligned with the first chamber hole;
placing a tube on the inner bladder sheet;
inserting a mandrel through the first and second chamber holes and supporting a first end of the tube;
placing an end bladder sheet over the inner bladder sheet and tube such that a second end of the tube extends outward of an outer perimeter of the end bladder sheet; and
forming a multi-chamber bladder by welding the tube and the outer perimeter of the end bladder sheet and inner bladder sheet together in a single welding operation.

7. The method of claim 6, including supporting the inner bladder sheet, the additional bladder sheet, and the end bladder sheet on a welding electrode.

8. The method of claim 7, including removing the multi-chamber bladder from the welding electrode subsequent to the welding operation.

9. The method of claim 8, including removing the mandrel from the tube and the multi-chamber bladder via the first and second chamber holes after removing the multi-chamber bladder from the welding electrode.

10. The method of claim 6, wherein the welding operation comprises a high frequency welding operation that provides a single attachment interface that attaches the tube and the outer perimeter of the inner bladder sheet and the end bladder sheet together.

11. The method of claim 6, wherein the mandrel comprises at least a first portion and a second portion that are non-colinear with each other.

12. The method of claim 11, wherein the first portion comprises a first linear bar and the second portion comprises a second linear bar that is perpendicular to the first linear bar.

13. The method of claim 6, including forming the bladder sheets from a polyurethane material.

14. An apparatus comprising:
a plurality of bladder sheets including
at least a first bladder sheet and a second bladder sheet attached to each other and having aligned chamber holes, and
a third bladder sheet that is stacked on the second bladder sheet and encloses one end of a bladder;
a welding electrode that supports the plurality of bladder sheets;
a tube positioned between the second and third bladder sheets such that one end of the tube extends outward of an outer perimeter of the plurality of stacked bladder sheets; and
a mandrel with one end held fixed and an opposite end inserted through the aligned chamber holes and engageable with an end of the tube.

15. The apparatus of claim 14, wherein the mandrel comprises at least a first portion and a second portion that are non-colinear with each other.

16. The apparatus of claim 15, wherein the first portion and the second portion are perpendicular to each other.

17. The apparatus of claim 15, wherein one of the first portion and the second portion is longer than the other of the first portion and the second portion.

18. The apparatus of claim 15, wherein one of the first portion and the second portion is associated with the tube and the other of the first portion and the second portion extends out of the bladder.

19. The apparatus of claim 14, wherein the welding electrode provides a single weld interface that attaches the tube and the outer perimeter of the second bladder sheet and the third bladder sheet together.

20. The apparatus of claim 19, wherein the first bladder sheet, the second bladder sheet, and the third bladder sheet comprise a multi-chamber bladder with the one end of the tube that extends outward of the outer perimeter of the plurality of bladder sheets being connectable to a fluid supply and the opposite end of the tube being in fluid communication with a chamber of the multi-chamber bladder.
